(19) United States
(12) Patent Application Publication
(10) Pub. No.: US 2026/0205679 A1
(43) Pub. Date: Jul. 16, 2026

(54) IMAGING APPARATUS, IMAGING METHOD, AND STORAGE MEDIUM

(71) Applicant: CANON KABUSHIKI KAISHA, Tokyo (JP)

(72) Inventor: Sohi KODAMA, Kanagawa (JP)

(21) Appl. No.: 19/415,925

(22) Filed: Dec. 11, 2025

(30) Foreign Application Priority Data
Jan. 15, 2025 (JP) 2025-005107

(51) Int. Cl. H04N 23/611; G06T 7/246; H04N 23/67

(52) U.S. Cl. CPC H04N 23/611; G06T 7/248; H04N 23/672; G06T 2207/10016; G06T 2207/30196

(57) ABSTRACT

An imaging apparatus detects a subject area by tracking a specific subject in consecutive images; detects area candidates of a local portion accompanying the subject from within the images; calculates similarity on the basis of a relative positional relation between the subject area and an area of the local portion associated with the subject in a past frame and a relative positional relation between the subject area and area candidates of the local portion in a current frame and calculates an association score on the basis of the similarity; and performs association between the subject and the local portion on the basis of the association score.

### BACKGROUND

### Field of the Technology

The present disclosure relates to an imaging apparatus, an imaging method, a storage medium, and the like.

### Description of the Related Art

Conventionally, detecting areas of a specific subject from within consecutive images and tracking the subject has been performed. Tracking means detecting areas of a desired subject from within images and tracking areas of the same subject among consecutive images. On the basis of results of tracking, an auto focusing process and the like for a camera capturing images are performed.

In Japanese Unexamined Patent Publication No. 2021-152578, a method in which tracking is performed while an entirety of a subject, which is a tracking target, and a part thereof are associated with each other is disclosed. In the case of a person, as the entirety and a part of a subject, for example, the entire human body is set as the entirety, and a face part is set as the part.

In Japanese Unexamined Patent Publication No. 2021-152578, as a method for associating the entirety with a part, a method in which association is performed on the basis of closeness of a distance between the position of the entirety and the position of a part on an image has been disclosed. Hereinafter, a “part” may be denoted as a “local portion”.

Japanese Unexamined Patent Publication No. 2021-152578 is an example of the related art.

However, the method described in Japanese Unexamined Patent Publication No. 2021-152578 uses distance information between a subject and a local portion as a determination criterion for association. Accordingly, for example, when different candidates for local portions are detected at places of the same distance for a subject, there is a problem that association between the subject and the local portion is incorrectly performed.

In addition, since a constant threshold is set in advance for a distance between a subject and a local portion, and association is performed in a case in which the distance is smaller than the threshold, depending on an imaging method and a category of the subject, there is a problem that the scales of the threshold and the distance described above do not match, and association cannot be correctly performed.

### SUMMARY

An imaging apparatus according to an embodiment of the present disclosure detects a subject area by tracking a specific subject in consecutive images, detects area candidates of a local portion accompanying the subject from within the images; calculates a similarity on the basis of a relative positional relation between the subject area and an area of the local portion associated with the subject in a past frame and a relative positional relation between the subject area and area candidates of the local portion in a current frame and calculates an association score on the basis of the similarity; and performs association between the subject and the local portion on the basis of the association score.

Further features of the present disclosure will become apparent from the following description of embodiments with reference to the attached drawings.

### BRIEF DESCRIPTION OF THE DRAWINGS

FIG. 1 is a diagram illustrating a hardware configuration example of an imaging apparatus 10 according to a first embodiment of the present disclosure.

FIG. 2 is a functional block diagram illustrating a configuration example of the imaging apparatus according to the first embodiment.

FIGS. 3A to 3E are functional block diagrams illustrating configuration examples of a similarity judging unit 202 according to the first embodiment to a fifth embodiment.

FIG. 4 is a flowchart illustrating a processing example of an imaging method executed by an imaging apparatus according to the first embodiment to the fifth embodiment.

FIGS. 5A to 5E are diagrams illustrating an example of consecutive images for describing the first embodiment to the fifth embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

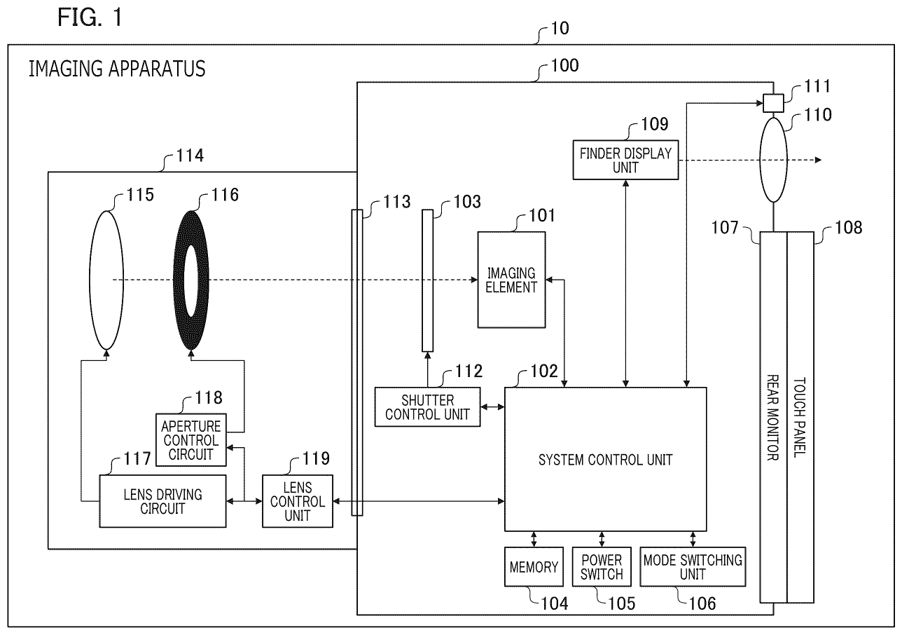

FIG. 1 is a diagram illustrating a hardware configuration example of an imaging apparatus 10 according to a first embodiment of the present disclosure. The imaging apparatus 10 is, for example, a digital camera with interchangeable lenses, is configured using a camera main body 100 and a lens unit 114 that guides incident light to an imaging element 101, and has the function of capturing an image in which multiple subjects are in focus in consideration of the spread of subjects in a depth direction.

In the present embodiment, an example of a digital camera with an interchangeable lenses type is described as an imaging apparatus. However, the imaging apparatus includes electronic devices having an imaging function such as a network camera, a digital movie camera, a smartphone provided with a camera, a tablet computer provided with a camera, an in-vehicle camera, a drone camera, and a camera mounted on a robot.

First, the camera main body 100 is described. The imaging element 101, for example, is configured using a CMOS-type imaging sensor and converts an optical image into an electrical signal. Light rays incident in on a photographic lens 115 form an image as an optical image on the imaging element 101 through an aperture 116 and a shutter 103.

A system control unit 102 has a CPU as a computer built thereinto and controls the camera main body 100. In addition, the system control unit 102 includes an image processing unit that performs image processing on a video signal acquired by the imaging element 101. The system control unit 102 or the entire imaging apparatus 10 functions as an image processing device (an information processing device). Furthermore, a part of the imaging apparatus 10 as an image processing device (an information processing device) may be disposed inside an external terminal disposed outside of the imaging apparatus 10.

In addition, the system control unit 102 further includes a phase difference AF unit that performs a focus detecting process using a phase difference detection system on the basis of focus detection image data (a signal for phase difference AF) acquired from the imaging element 101 and the image processing unit. Here, AF is an abbreviation of auto focusing.

In other words, each pixel of the imaging element 101 has one pair of photoelectric conversion units, detects one pair of pieces of image data formed in accordance with light beams passing through one pair of pupil regions of an imaging optical system, and outputs focus detection image data. The phase difference AF unit of the system control unit 102 performs phase difference AF (imaging surface phase difference AF) of calculating a distance to a subject on the basis of the amount of defocus together with calculating the amount of defocus on the basis of the amount of deviation between the one pair of pieces of image data described above.

The memory 104 stores a computer program for operating a CPU of the system control unit 102, variables, constants, and the like. In addition, this memory 104 includes an electrically erasable/recordable non-volatile memory and stores setting values such as various parameters and an ISO sensitivity, an image-capturing mode, various kinds of correction data, and the like.

A power switch 105 performs switching of power on/off of the camera main body 100. A mode switching unit 106 is a switch used for switching settings of various image-capturing modes such as live view image-capturing and video image-capturing.

A rear monitor 107 is configured using a liquid crystal device, an LED, and the like displaying an operation state, a message, and the like of the imaging apparatus and image-capturing information using text, an image, and the like in accordance with the execution of a computer program of the system control unit 102.

A touch panel 108 is arranged in an area that is approximately equal to the rear monitor 107. In addition, the touch panel 108, for example, configures a GUI used for detecting a contact of a finger or a pen, notifying the system control unit 102 of a contact position with respect to the rear monitor 107, and executing an operation or a function associated with the contact position.

A finder display unit 109, similar to the rear monitor 107, includes an LED or the like displaying image-capturing information in accordance with the execution of a computer program in the system control unit 102 and configures an electronic viewfinder (EVF) together with an eyepiece 110.

In addition, an eye contact detecting unit 111 is provided, and the system control unit 102 selectively displays the image-capturing information described above either on the rear monitor 107 or on the finder display unit 109 in accordance with an eye-contact state of an image-capturer.

A shutter control unit 112 controls operations (an exposure period and the like) of a shutter 103 on the basis of a subject light measurement result (brightness information) calculated by the system control unit 102. The shutter 103 can be controlled in conjunction with the aperture 116.

Next, the configuration of the lens unit 114 is described. The camera main body 100 and the lens unit 114 are mechanically and electrically coupled through a lens mount mechanism 113 and are attachable/detachable to/from each other.

The lens unit 114 is configured using a photographic lens 115, an aperture 116, a lens driving circuit 117, an aperture control circuit 118, a lens control unit 119, and the like. For simplification, although only one photographic lens 115 is illustrated in FIG. 1, actually, a group of multiple photographic lenses are configured.

The lens control unit 119 has a CPU as a computer and the like and controls the entire lens unit 114. The lens control unit 119 includes a memory that stores various constants, variables, computer programs, and the like for lens operations. In addition, a non-volatile memory that stores a maximum aperture value, a minimum aperture value, a focal distance, and the like, which are information unique to the lens unit, is also provided.

The system control unit 102 of the camera main body 100 calculates a defocus amount using output information of the imaging element 101. Then, the system control unit 102 calculates a subject distance on the basis of the calculated defocus amount and controls the lens driving circuit 117 by performing communication via the lens control unit 119 of the lens unit 114, thereby causing the subject to be in focus.

In the following example, consecutive images are input, an entire subject that is a tracking target is tracked from within the images, a local portion accompanying the subject is detected, and association between the local portion and the subject is performed. At that time, in the present embodiment, association between a subject and a local portion of the current frame is performed on the basis of an angular similarity between vectors joining subject areas and local portion areas of a past frame and a current frame.

Hereinafter, as one example, an example in which the subject entirety is a person body, and a local portion is the head of a person is described. However, the present disclosure is not limited thereto. The subject entirety may be set as a face of a person, and the local portion may be set as a pupil of a person.

Alternatively, a subject may be set as a whole body of an animal, and a local portion may be set as a face of the animal. In addition, a local portion may accompany a subject that is a tracking target and does not necessarily need to be a part of an object that is the subject.

For example, the entire subject may be a vehicle with a person riding therein, and the local portion may be the head of the person. Although the head of a person is not a part of the vehicle, since it moves in accordance with the tracked vehicle, it can be regarded as a local portion for the tracked subject entirety.

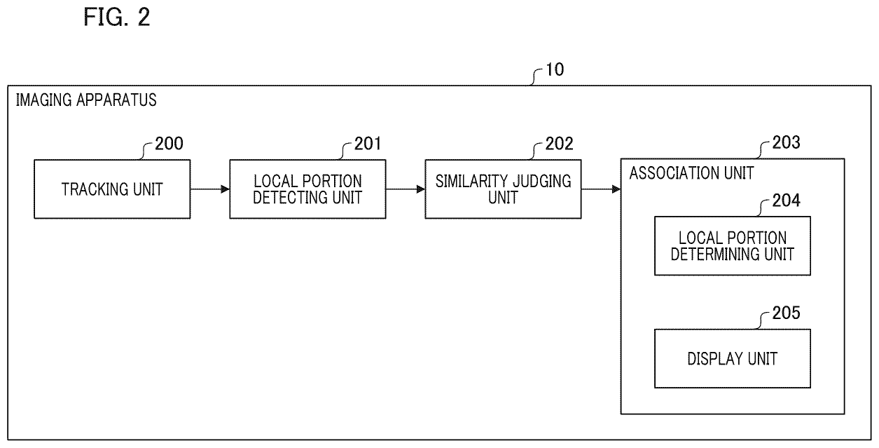

FIG. 2 is a functional block diagram illustrating a configuration example of the imaging apparatus according to the first embodiment. Some of functional blocks illustrated in FIG. 2 are realized by causing a CPU or the like as a computer, which is not illustrated, included in the system control unit 102 of the imaging apparatus 10 to execute a computer program stored in a memory as a storage medium that is not illustrated in the drawing.

However, some or all thereof may be realized by hardware. As the hardware, a dedicated circuit (ASIC), a processor (a reconfigurable processor, a DSP), or the like can be used.

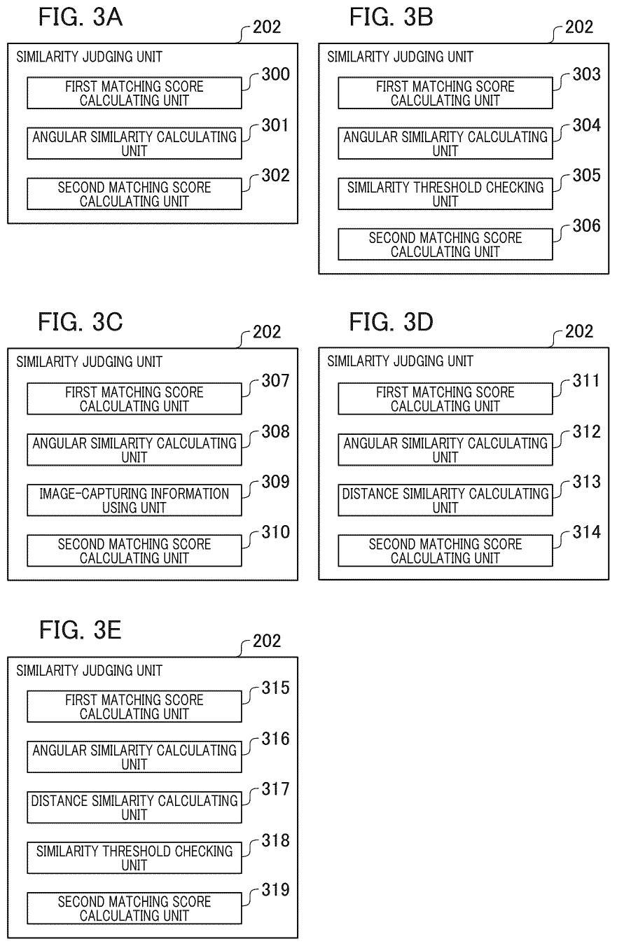

The functional blocks illustrated in FIG. 2 may not be built into the same casing and may be configured using other devices connected via a signal line. The description relating to FIG. 2 described above also applies to FIGS. 3A to 3E.

As illustrated in FIG. 2, the imaging apparatus 10 has a tracking unit 200, a local portion detecting unit 201, a similarity judging unit 202, an association unit 203, a local portion determining unit 204, and a display unit 205, and each function is executed by the CPU of the system control unit 102.

The tracking unit 200 detects a subject area of a tracking target for an input image and outputs the input image and the detected subject area to the local portion detecting unit 201. The tracking unit 200 functions as a tracking means that tracks a specific subject in consecutive images and detects a subject area.

The local portion detecting unit 201 detects area candidates of a local portion on the basis of a subject area in an image and outputs the input image, the subject area, and the area candidates of the local portion to the similarity judging unit 202. The local portion detecting unit 201 functions as a local portion detecting means that detects area candidates of a local portion accompanying a subject from within an image.

The similarity judging unit 202 calculates a second association score A2n in the current frame from a relative positional relation between subjects and candidates of local portions in the past frame and the current frame. In addition, the similarity judging unit 202 functions as a similarity judging means that calculates an association score on the basis of the similarity.

In other words, the similarity judging unit 202 calculates similarity on the basis of a relative positional relation between a subject area and the area of a local portion associated with the subject in the past frame and a relative positional relation between a subject area and an area candidate of the local portion in the current frame.

FIGS. 3A to 3E are diagrams illustrating configuration examples of the similarity judging unit 202 according to the first embodiment. A similarity judging unit 202 illustrated in FIG. 3A has a first matching score calculating unit 300, an angular similarity calculating unit 301, and a second matching score calculating unit 302.

The first matching score calculating unit 300 functions as a first matching score calculating means and calculates a first association score A1n between a subject and an area candidate of the local portion. The first association score A1n is described below.

The angular similarity calculating unit 301 calculates angular similarity Sn between “a vector joining a subject area and an area of a local portion associated with the subject in an image of the past frame” and “a vector joining a subject area and each area candidate of the local portion in an image of the current frame”.

In addition, the angular similarity calculating unit 301 functions as an angular similarity calculating means that calculates angular similarity between a relative positional relation between a subject area and an area of a local portion associated with the subject area in the past frame and a relative positional relation between a subject area and an area candidate of the local portion in the current frame.

Hereinafter, “a vector joining a subject area and an area of a local portion associated with the subject in the image of the past frame” is abbreviated as a “past vector”. Hereinafter, “a vector joining a subject area and an area candidate of each local portion in the image of the current frame” is abbreviated as a “current vector”.

The second matching score calculating unit 302 functions as a second matching score calculating means that calculates a second association score A2n between a subject and a candidate of a local portion on the basis of the calculated first association score A1n and the angular similarity Sn. The second association score is described below. The image, the subject area, the area candidate of the local portion, and the second association score A2n are output to the association unit 203.

The association unit 203 performs association between a subject and a local portion accompanying the subject in the image on the basis of the second association score A2n and displays the area of the associated local portion. As illustrated in FIG. 2, the association unit 203 has a local portion determining unit 204 and a display unit 205. In addition, the association unit 203 functions as an association means that performs association between a subject and a local portion on the basis of an association score.

The local portion determining unit 204 selects one local portion accompanying the subject in the image from candidates of a plurality of local portions on the basis of the second association score A2n. In addition, the local portion determining unit 204 functions as a local portion determining means that selects an area of a local portion associated with the subject area in the current frame on the basis of the second association score.

The display unit 205 displays the area of the selected local portion on the rear monitor 107. The display unit 205 functions as a display means that displays the area of an associated local portion on the screen.

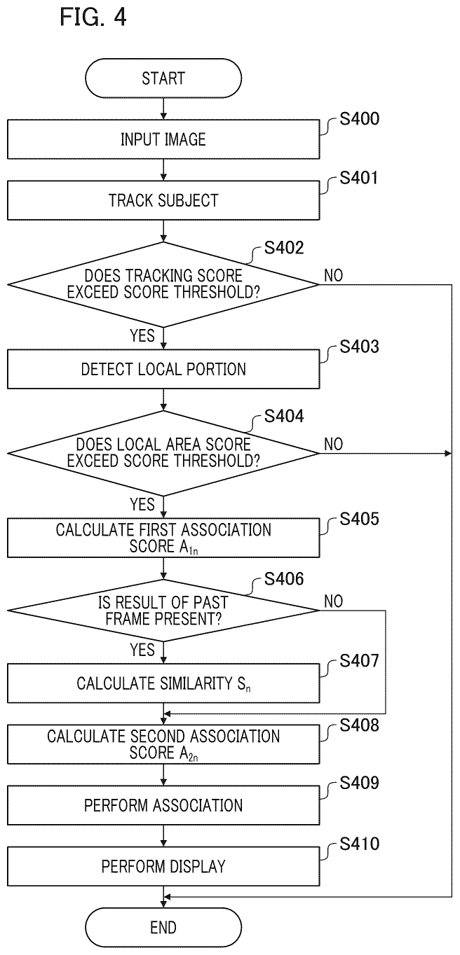

FIG. 4 is a flowchart illustrating a process example of an imaging method executed by imaging apparatuses according to the first embodiment to a fifth embodiment. In accordance with a CPU or the like as a computer inside of the system control unit 102 executing a computer program stored in a memory, the operations of respective steps of the flowchart illustrated in FIG. 4 are sequentially performed.

Next, a process performed by the imaging apparatus 10 according to the present embodiment is described in detail along the flowchart illustrated in FIG. 4. The process flow illustrated in FIG. 4 is periodically executed in units of frames. However, the imaging apparatus does not necessarily need to perform all the steps described in this flowchart.

In Step S400, imaging is performed using the imaging apparatus 10, and a captured image recorded in the memory 104 is acquired. After information at the time of image capturing such as settings of the camera and the like are assigned to a captured image, the resultant image is input to the tracking unit 200.

In Step S401, a subject area of a tracking target is detected for an input image, and the subject is tracked. For this reason, first, a template of a subject that is a tracking target of the tracking unit 200 is registered. The registration of a template may be performed by allowing a user to select a desired subject on the screen or the like. Here, Step S401 functions as a tracking step of detecting a subject area by tracking a specific subject in consecutive images.

In the present embodiment, an example in which the whole body of a person is tracked is described. Here, it is assumed that a whole body image of a person who is a tracking target is registered as a template. In the present embodiment, although the process of a tracking means is described using a method in which a template for tracking is registered, and a tracking process is performed through template matching, a specific method of the tracking process according to the present disclosure is not limited thereto.

In addition, in Step S401, the tracking unit 200 acquires one-frame images that are consecutively input, searches an area on the current image that is similar to a template, and outputs a plurality of subject area candidates and tracking scores thereof. A tracking score is a numerical value that represents the reliability of a tracking result, and it is assumed that the higher the numerical value, the more reliable the tracking result.

A tracking score for a candidate is calculated using a degree of matching with a subject area in the previous frame, image similarity between a subject area and a template, and the like. As a tracking means, methods using template matching and a neural network and the like are widely known, and thus detailed description thereof is omitted here.

In Step S402, the tracking unit 200 judges whether or not a tracking score exceeding a predetermined score threshold is present. In a case in which No is judged in Step S402, the process flow illustrated in FIG. 4 ends.

On the other hand, in a case in which Yes is judged in Step S402, the tracking unit 200 outputs a subject area corresponding to the highest tracking score among tracking scores exceeding the predetermined score threshold to the local portion detecting unit 201 together with the image, and the process proceeds to Step S403. A subject area, for example, is an area including a person and the like and is displayed using a position, a size, and the like of the bounding box on the image by the display unit 205.

In Step S403, the local portion detecting unit 201 performs detection of a local portion. In other words, the local portion detecting unit 201 detects an area of a local portion that accompanies a subject and is a tracking target from within input images and subject areas and outputs an area candidate of a local portion and a score of the local area. Here, Step S403 functions as a local portion detecting step of detecting an area candidate of a local portion accompanying a subject from within the image described above.

A range in which detection of a local portion area is performed may be an entire image or may be determined on the basis of the subject area. In the present embodiment, since an example in which the head of a person is detected as a local portion is described, the local portion detecting unit 201 is assumed to perform the process of detecting an area that is the head of a person on the image.

A local area score is a numerical value representing the reliability of a detection result, and it is assumed that the higher a numerical value, the more reliable a detection result. As a local portion detecting means, by using a general object detecting method, a local portion accompanying a subject may be detected.

As a general object detecting method, an object detecting method using a neural network is widely known, and detailed description thereof is omitted here. The object detecting method according to the present disclosure is not limited to the object detecting method using a neural network.

Since there are cases in which a plurality of objects that are detection targets are present in one image, it cannot be determined that an object detection result for one image becomes one area, and the detection result may be a plurality of areas.

In Step S404, the local portion detecting unit 201 judges whether or not a local area score exceeding the predetermined score threshold is present. In a case in which Yes is judged in Step S404, in other words, in a case in which the local area score exceeds the predetermined score threshold, the corresponding local area is extracted as a candidate of the local area, and the image, the subject area, and the area candidate of the local portion are output to the similarity judging unit 202.

In addition, the area candidate of the local portion may be displayed using a position, a size, and the like of a bounding box on the image. In a case in which No is judged in Step S404, in other words, in a case in which no area candidate of the local portion of which the local area score exceeds the predetermined score threshold is present, the process flow illustrated in FIG. 4 ends.

In Step S405, the first matching score calculating unit 300 of the similarity judging unit 202 illustrated in FIG. 3A calculates a first association score A1n between the subject and the candidate of the local portion. The first association score A1n is a numerical value representing the reliability of association between a subject and a candidate of the local portion accompanying the subject, and it is assumed that the higher the numerical value, it is more reliable that the candidate is a local portion accompanying the subject.

Here, n is a sequence corresponding to each of a plurality of local portion area candidates, and first association scores A1n corresponding to the number of candidates of the local portion are calculated. The first association score A1n is calculated as a matching score of each local portion, for example, using posture estimation using a neural network or the like. In other words, for example, the matching score for each local candidate is calculated using a bone map joining the center (the center of gravity) of the whole body and the center (the center of gravity) of the local area or the like.

In Step S405, information of the first association score A1n is assigned to an area candidate of each local portion.

In Step S406, the angular similarity calculating unit 301 of the similarity judging unit 202 illustrated in FIG. 3A judges whether or not an association result between a subject and a local portion in the image of the past frame is present. Then, the process is caused to branch on the basis of the judgment result.

Past frames represent frames that fall within a threshold in the range of “the number of frames counted backward from the current frame” set in advance. Hereinafter, “the number of frames counted backward from the current frame” is denoted as “elapsed frame number”. In the present embodiment, “the elapsed frame number” is set to 1, and it is judged whether or not an association result is present in an image of one frame before.

In a case in which Yes is judged in Step S406, the process proceeds to Step S407, and in a case in which No is judged in Step S406, in other words, in a case in which no association result is present in the past frame within “elapsed frame number”, the process proceeds to Step S408.

In Step S407, the angular similarity calculating unit 301 of the similarity judging unit 202 calculates angular similarity Sn by comparing relative positional relations between the subject areas and the areas of the local portions in the past frame and the current frame with each other.

More specifically, angular similarity Sn between a past vector and a current vector is calculated as below. The past vector, for example, is set as a vector that joins a center point (the center of gravity) of the subject area and a center point (the center of gravity) of the area of the local portion in the past frame.

The current vector, for example, is set as a vector that joins a center point (the center of gravity) of the subject area and a center point (the center of gravity) of the area candidate of the local portion in the current frame. Current vectors corresponding to the number of area candidates of the local portion are present. The angular similarity Sn represents a degree of closeness between directions (angles) of a past vector and each of a plurality of current vectors.

The similarity between a past vector and the current vector can be calculated, for example, using cosine similarity or the like but is not limited thereto. In the present embodiment, a past frame to be used is only one frame. However, the angular similarity Sn between a past frame and the current frame may be calculated by calculating respective angular similarities between a plurality of past vectors of past frames and the current vector and calculating a weighted average of the angular similarities described above in accordance with the elapsed frame numbers of the past frames.

Next, to the area candidate of each local portion, information of the angular similarity Sn of the current vector joining the center (the center of gravity) of the local portion and the subject area is assigned.

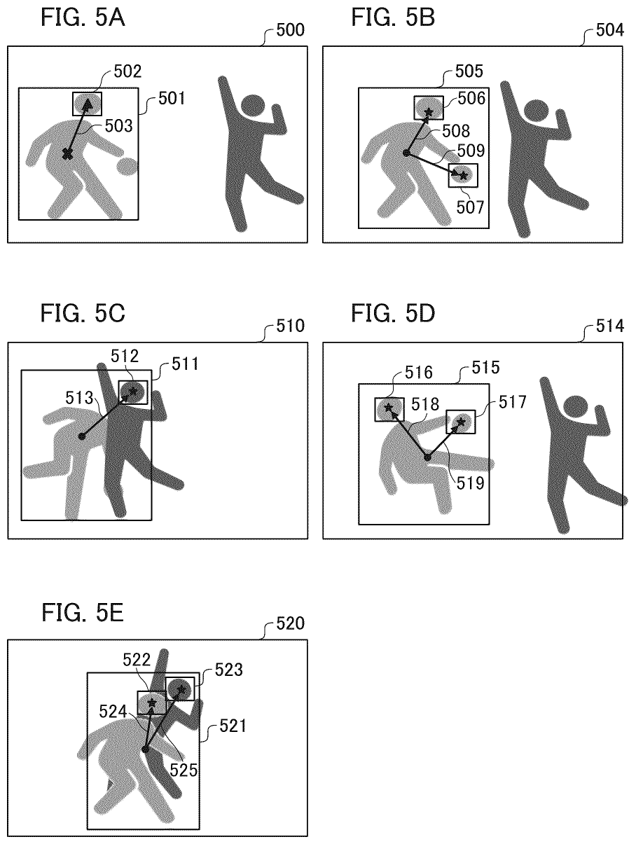

FIGS. 5A to 5E are diagrams illustrating examples of consecutive images for describing the first embodiment to the fifth embodiment, and FIG. 5A represents an example of the image of a frame that is one frame before the current frame, that is, the image of a past frame. A past frame image 500, a subject area 501, a local portion area 502, and a past vector 503 joining the center of the subject area 501 and the center of the local portion area 502 are illustrated.

FIG. 5B illustrates an example of the image of the current frame according to the first embodiment. A current frame image 504, a subject area 505, a local portion area 506, and a local portion area candidate 507 are illustrated.

In addition, a current vector 508 joining the center of the subject area 505 and the center of the local portion area 506 and a current vector 509 joining the center of the subject area 505 and the center of the local portion area 507 are illustrated.

The local portion area 506 that is originally desired to be associated with the subject area 505 is correct detection of the local portion area, and the local portion area 507 is incorrect detection. In the present embodiment, angular similarity S1 between the past vector 503 and the current vector 508 and angular similarity S2 between the past vector 503 and the current vector 509 are respectively calculated.

Since the angle with respect to the past vector 503 is more similar in the current vector 508 than in the current vector 509 (the cosine similarity is high), the angular similarity S1 is higher than the angular similarity S2.

In Step S408, the second matching score calculating unit 302 of the similarity judging unit 202 illustrated in FIG. 3A calculates a second association score A2n between the subject and the candidate of the local portion as below.

A second association score A2n is calculated for each area candidate of the local portion on the basis of the first association score A1n and/or the angular similarity Sn in the information of the area candidate of each local portion. The calculation of the second association score A2n, for example, is performed as in the following Equation 1. However, the calculation is not limited to Equation 1.

$${A}_{2 n} = {A}_{1 n} \times {S}_{n} \qquad ( Equation 1 )$$

The second association score A2n is acquired by correcting the value of the first association score A1n using the angular similarity Sn. For example, a case in which the first association score A11 of the local portion area 506 illustrated in FIG. 5B and the first association score A12 of the local portion area 507 are of the same degree is considered. In that case, the second association score A21 of the local portion area 506 becomes higher than the second association score A22 of the local portion area 507.

In addition, in a case in which No is judged in Step S406, in other words, in a case in which no association result is present in the past frame, the value of the first association score A1n is set as the second association score A2n. Then, the image, the subject area, the area candidate of the local portion, and the second association score A2n are output to the association unit 203.

In this way, in Steps S405 to S408, the similarity is calculated on the basis of the relative positional relation between the subject area and the area of the local portion associated with the subject in the past frame and the relative positional relation between the subject area and the area candidate of the local portion in the current frame. Then, an association score is calculated on the basis of the similarity. Here, Steps S405 to S408 function as a similarity judging step.

In Step S409, the local portion determining unit 204 of the association unit 203 selects a local portion of which the second association score A2n is the highest among candidates of the local portion as a local portion accompanying the subject, and the selected local portion is associated. Here, Step S409 functions as an association step of associating a subject and local portions with each other on the basis of the association scores.

In the present embodiment, since the second association score A21 is higher than the second association score A22, the local portion area 506 illustrated in FIG. 5B becomes the area of the selected local portion.

In Step S410, the display unit 205 of the association unit 203 displays the area of the selected local portion with being superimposed onto the image on the rear monitor 107. In the present embodiment, the bounding box of the local portion area 507 is not displayed in the current frame image 504 illustrated in FIG. 5B, and an image onto which the bounding box of the local portion area 506 is superimposed is displayed.

In addition, on the basis of the displayed local portion area 506, processes such as auto focusing and exposure control and the like are performed. However, the displayed information is not limited thereto, and the bounding box of the subject area 505 and the like may be displayed with being superimposed onto the current frame image 504.

By performing Steps S400 to S410 as described above, for example, when a plurality of candidates of the local portion are present, association between a subject and a local portion accompanying the subject can be performed more correctly.

### Second Embodiment

In each of the following embodiments including the present embodiment, differences from the first embodiment are described, and, unless otherwise specified, the configuration is similar to that of the first embodiment.

In the second embodiment, a predetermined threshold is set to the angular similarity according to the first embodiment, the second association score A2n is calculated on the basis of a result of comparison between the angular similarity with the predetermined threshold, and association is performed.

FIG. 3B is a functional block illustrating a configuration example of a similarity judging unit 202 according to the second embodiment. The similarity judging unit 202 according to the second embodiment has a first matching score calculating unit 303, an angular similarity calculating unit 304, a similarity threshold checking unit 305, and a second matching score calculating unit 306.

The first matching score calculating unit 303 and the angular similarity calculating unit 304 respectively perform processes similar to those of the first matching score calculating unit 300 and the angular similarity calculating unit 301 according to the first embodiment, and thus description thereof is omitted.

The similarity threshold checking unit 305 updates the numerical value of angular similarity Sn by comparing the angular similarity Sn with an angular similarity threshold Ts set in advance. The similarity threshold checking unit 305 functions as a similarity threshold checking means that calculates a comparison result by comparing angular similarity with a predetermined similarity threshold, and the second matching score calculating unit 306 calculates a second association score on the basis of the comparison result described above and the first association score.

The second matching score calculating unit 306 performs a process similar to that of the second matching score calculating unit 302 according to the first embodiment, and thus description thereof is omitted.

Next, the process performed by the imaging apparatus 10 according to the second embodiment is described in detail along the flowchart illustrated in FIG. 4. However, the imaging apparatus may not necessarily need to perform all the steps described in this flowchart.

In Steps S400 to S406, processes similar to those of Steps S400 to S406 according to the first embodiment are performed, and thus description thereof is omitted.

In Step S407, first, the angular similarity calculating unit 304 of the similarity judging unit 202 calculates angular similarity Sn on the basis of a relative positional relation between a subject area and an area of a local portion in each of the past frame and the current frame.

In other words, angular similarity Sn between the past vector and the current vector is calculated. Next, the similarity threshold checking unit 305 updates the numerical value of the angular similarity Sn by comparing the angular similarity Sn with the angular similarity threshold Ts. Thereafter, information of the angular similarity Sn of the current vector joining the center and a subject area is assigned to an area candidate of each local portion.

FIG. 5A illustrates an example of an image of a past frame as described above. The configuration illustrated in FIG. 5A is similar to that according to the first embodiment illustrated in FIG. 5A, and thus description thereof is omitted. FIG. 5C illustrates an example of an image of the current frame according to the second embodiment.

In FIG. 5C, a current frame image 510, a subject area 511, a local portion area 512, and a current vector 513 joining the center of a subject area 511 and the center of a local portion area 512 are illustrated.

Furthermore, a local portion area candidate that is originally desired to be associated with the subject area 511 has not been detected due to occlusion by another subject, and the local portion area 512 is incorrectly detected. However, in the present embodiment, for example, in a scene illustrated in FIG. 5C, incorrect association with the local portion area 512 can be suppressed. In addition, here, although an example in which only one local portion area candidate is present is described, also in a case in which two or more local portion area candidates are present, the present embodiment is effective.

In this second embodiment, as described above, in Step S407, first, the angular similarity calculating unit 304 calculates the angular similarity S1 between the past vector 503 and the current vector 513. Next, the similarity threshold checking unit 305 updates the value of the angular similarity S1 on the basis of the angular similarity S1 and the angular similarity threshold Ts. The method of updating the angular similarity S1, for example, is performed as in the following Equation 2 but it not limited thereto.

$${S}_{n} = max ( \begin{matrix}{S}_{n} - {T}_{s} \\ 0\end{matrix} ) \qquad ( Equation 2 )$$

In a case in which a value acquired by subtracting Ts from the angular similarity Sn is larger than 0, the value is set as the angular similarity Sn. In a case in which the value acquired by subtracting Ts from the angular similarity Sn is 0 or less, the value of the angular similarity Sn is set as 0. For example, in examples illustrated in FIGS. 5A and 5C, an angle between the past vector 503 and the current vector 513 is large, and the angular similarity S1 is lower than the angular similarity threshold Ts, whereby the angular similarity S1 becomes 0.

In addition, although one angular similarity threshold Ts may be used, the angular similarity threshold may be prepared for each category of subjects. Furthermore, as in a third embodiment described below, each angular similarity threshold Ts may be corrected for each frame on the basis of the image-capturing information of the camera.

In Step S408, the second matching score calculating unit 306 of the similarity judging unit 202 calculates a second association score A2n between a subject and a candidate of the local portion. Although a representative process is the same as that of Step S408 of the first embodiment, the angular similarity S1 is 0 in the present embodiment, and thus the second association score A21 of the local portion area 512 becomes 0 in accordance with Equation 1.

Furthermore, in Step S408, the image, the subject area, the area candidate of the local portion, and the second association score A21 are output to the association unit 203.

In Step S409, the local portion determining unit 204 of the association unit 203 selects a local portion of which the second association score A2n is the highest among candidates of the local portion as a local portion accompanying the subject, and the local portion is associated. In the example illustrated in FIG. 5C, since the value of only one second association score A21 is 0, and thus association is not performed.

In Step S410, the display unit 205 of the association unit 203 displays the area of the selected local portion on the rear monitor 107 with being superimposed onto the image. In the example illustrated in FIG. 5C, since association is not performed, and thus only the current frame image 510 is displayed. Since no associated local portion is present, process of the auto focusing and the like are not performed.

As above, by performing Steps S400 to S410, for example, when only one candidate of the local portion is present, incorrect association between a subject and a local portion candidate not accompanying the subject can be suppressed.

### Third Embodiment

In a third embodiment, an example in which association between a subject area and a local portion area is performed on the basis of image-capturing information that is acquired when a user captures an image as image-capturing information and angular similarity between vectors joining subject areas and areas of the local portion in the past frame and the current frame is described.

FIG. 3C is a functional block diagram illustrating a configuration example of a similarity judging unit 202 according to the third embodiment. The similarity judging unit 202 according to the third embodiment has a first matching score calculating unit 307, an angular similarity calculating unit 308, an image-capturing information using unit 309, and a second matching score calculating unit 310.

The first matching score calculating unit 307 and the angular similarity calculating unit 308 respectively perform the same processes as those of the first matching score calculating unit 300 and the angular similarity calculating unit 301 according to the first embodiment, and thus description thereof is omitted.

The image-capturing information using unit 309 extracts necessary information at the time of image capturing from an image and updates the numerical value of the angular similarity Sn using the extracted information. In addition, the image-capturing information using unit 309 functions as an image-capturing information using means that acquires image-capturing information at the time of capturing an image, and the second matching score calculating unit 310 calculates a second association score on the basis of the image-capturing information, the angular similarity, and the first association score. The information at the time of image capturing is described below.

The second matching score calculating unit 310 performs the same process as that of the second matching score calculating unit 302 according to the first embodiment, and thus description thereof is omitted.

Next, the process performed by the imaging apparatus 10 according to the third embodiment is described in detail along the flowchart illustrated in FIG. 4. However, the imaging apparatus may not necessarily need to perform all the steps described in this flowchart.

In Steps S400 to S406, processes similar to those of Steps S400 to S406 according to the first embodiment are performed, and thus description thereof is omitted.

In Step S407, first, the angular similarity calculating unit 308 of the similarity judging unit 202 calculates angular similarity Sn on the basis of a relative positional relation between a subject area and an area of a local portion in each of the past frame and the current frame. More specifically, the angular similarity Sn between the past vector and the current vector is calculated.

Next, the image-capturing information using unit 309 extracts necessary information at the time of image capturing from an image and updates the numerical value of the angular similarity Sn using the extracted information. The information at the time of image capturing, for example, includes at least one of a frame rate, a focal distance, and a distance from the camera to a subject.

Although the frame rate is used in the present embodiment, two pieces or more of the information at the time of image capturing may be extracted and used in combination thereof. In Step S407, finally, to the area candidate of each local portion, the information of the angular similarity Sn of the current vector joining the center and the subject area is assigned.

FIG. 5A illustrates an example of the image of the past frame. The configuration illustrated in FIG. 5A is similar to that according to the first embodiment illustrated in FIG. 5A, and thus description thereof is omitted.

FIG. 5D illustrates an example of the image of the current frame according to the present embodiment. In FIG. 5D, a current frame image 514, a subject area 515, a local portion area 516, and a local portion area 517 are illustrated.

In addition, in FIG. 5D, a current vector 518 joining the center of the subject area 515 and the center of the local portion area 516 and a current vector 519 joining the center of the subject area 515 and the center of the local portion area 517 are illustrated. Furthermore, a local portion area 516 that is originally desired to be associated with the subject area 515 is correct detection of the local portion area, and the local portion area 517 is incorrect detection.

In the present embodiment, in Step S407, first, the angular similarity calculating unit 308 calculates the angular similarity S1 between the past vector 503 and the current vector 518 and the angular similarity S2 between the past vector 503 and the current vector 519.

Since the current vector 519 has an angle more similar to that of the past vector 503 (higher cosine similarity) than the current vector 518, the angular similarity S2 is calculated to be higher than the angular similarity S1.

Next, the image-capturing information using unit 309 extracts the frame rate at the time of image capturing from the image from the information assigned to the image 514 and updates the numerical value of the angular similarity Sn, for example, as in the following Equation 3 using the extracted frame rate.

$${S}_{n} = {( 1 + {S}_{n} )}^{max ( \begin{matrix}F - {F}_{T} \\ 0\end{matrix} ) \times w} \qquad ( Equation 3 )$$

In Equation 3, F is a frame rate, FT is a threshold of the frame rate that is set in advance, and w is a weight of the image-capturing information and is a numerical value larger than 0. In a case in which the frame rate F is greater than the threshold FT, a value acquired by subtracting the threshold FT from the frame rate F is raised to the power of the angular similarity Sn.

The higher the frame rate F, a relative positional change of the subject in the current frame with respect to the past frame becomes smaller, and thus, the reliability level of the angular similarity Sn becomes high, and the high angular similarity Sn is updated with a higher numerical value.

In a case in which the frame rate F is lower than the threshold FT, the reliability level of the angular similarity Sn becomes low, and thus the angular similarity Sn is updated to be uniformly 1. In other words, the value of the first association score becomes the second association score without the angular similarity Sn being into consideration. In the present embodiment, F is 20 fps, and FT is 30 fps. In accordance with Equation 3, the angular similarity S1 and the angular similarity S2 become 1.

In Step S408, the second matching score calculating unit 310 of the similarity judging unit 202 calculates a second association score A2n between the subject and the candidate of the local portion, for example, in accordance with Equation 1.

In the present embodiment, the first association score A11 of the local portion area 516 illustrated in FIG. 5D is assumed to be greater than the first association score A12 of the local portion area 517. In other words, in accordance with Equation 1, the second association score A21 of the local portion area 516 becomes higher than the second association score A22 of the local portion area 517. In Step S408, the image, the subject area, the area candidate of the local portion, and the second association score A2n are output to the association unit 203.

In Step S409, the local portion determining unit 204 of the association unit 203 selects a local portion of which the second association score A2n is the highest among candidates of the local portion as a local portion accompanying the subject, and the local portion is associated. In the present embodiment, since the second association score A21 is higher than the second association score A22, the local portion area 516 illustrated in FIG. 5D becomes the area of the selected local portion.

In Step S410, the display unit 205 of the association unit 203 displays the area of the selected local portion on the rear monitor 107 with being superimposed onto the image. In the present embodiment, in the current frame image 514 illustrated in FIG. 5D, the bounding box of the local portion area 517 is not displayed, and an image onto which the bounding box of the local portion area 516 is superimposed is displayed.

In addition, on the basis of the displayed local portion area 516, processes such as auto focusing and exposure control and the like are performed. However, the displayed information is not limited thereto, and the bounding box of the subject area 515 and the like may be displayed with being superimposed onto the current frame image 514.

As above, by performing Steps S400 to S410, for example, when a plurality of candidates of the local portion are present, association between a subject and a local portion accompanying the subject can be performed more accurately by taking the information at the time of image capturing into account.

### Fourth Embodiment

In a fourth embodiment, a method of performing association between a subject area and a local portion area on the basis of angular similarity and distance similarity between vectors joining respective subject areas and respective local portion areas in the past frame and the current frame is described.

FIG. 3D is a functional block diagram illustrating a configuration example of a similarity judging unit 202 according to the fourth embodiment. The similarity judging unit 202 according to the fourth embodiment has a first matching score calculating unit 311, an angular similarity calculating unit 312, a distance similarity calculating unit 313, and a second matching score calculating unit 314.

The first matching score calculating unit 311 and the angular similarity calculating unit 312 respectively perform the same processes as those of the first matching score calculating unit 300 and the angular similarity calculating unit 301 according to the first embodiment, and thus description thereof is omitted. The angular similarity calculating unit 312 calculates distance similarity Dn between a past vector and a current vector.

The distance similarity calculating unit 313 functions as a distance similarity calculating means that calculates distance similarity between a relative positional relation between a subject area and an area of a local portion associated with the subject area in the past frame and a relative positional relation between a subject area and an area candidate of a local portion in the current frame.

The second matching score calculating unit 314 functions as a second matching score calculating means and calculates a second association score A2n between a subject and a local portion candidate on the basis of the calculated first association score A1n, the angular similarity Sn, and the distance similarity Dn. In addition, the second matching score calculating unit 314 outputs the image, the subject area, the area candidate of the local portion, and the second association score A2n to the association unit 203.

Next, the process performed by the imaging apparatus 10 according to the fourth embodiment is described in detail along the flowchart illustrated in FIG. 4. However, the imaging apparatus may not necessarily need to perform all the steps described in this flowchart.

In Steps S400 to S406, processes similar to those of Steps S400 to S406 according to the first embodiment are performed, and thus description thereof is omitted.

In Step S407, first, the angular similarity calculating unit 312 of the similarity judging unit 202 calculates angular similarity Sn on the basis of a relative positional relation between a subject area and an area of a local portion in each of the past frame and the current frame.

In other words, angular similarity Sn between the past vector and the current vector is calculated. Next, the distance similarity calculating unit 313 calculates distance similarity Dn on the basis of a relative positional relation between a subject area and an area of a local portion in each of the past frame and the current frame.

In addition, the distance similarity calculating unit 313 functions as a distance similarity calculating means that calculates distance similarity between a relative positional relation between a subject area and an area of a local portion associated with the subject area in the past frame and a relative positional relation between a subject area and an area candidate of a local portion in the current frame.

More specifically, distance similarity Dn between a past vector and a current vector is calculated as below. The distance similarity Dn represents a degree of closeness between lengths of the past vector and the current vector.

Each of the lengths of the past vector and the current vector can be calculated, for example, using an Euclidean distance or the like, and the distance similarity Dn can be calculated, for example, by using the following Equation (4), but the calculation is not limited thereto.

$${D}_{n} = 1 / ( \vert {L}_{0} - {L}_{n} \vert + 1 e - 5 ) \qquad ( Equation 4 )$$

In Equation 4, L0 represents the length of the past vector, Ln represents the length of the current vector, and 1e-5 represents 1×10⁻⁵. The closer the length L0 of the past vector and the length of the current vector Ln, the larger the distance similarity Dn is calculated.

In the fourth embodiment, although only one past frame is employed, the distance similarity Dn between the past frame and the current frame may be calculated by taking a weighted average of the distance similarity in accordance with an elapsed frame number of each of the past frames. In Step S407, finally, to the area candidate of each local portion, information of the angular similarity Sn and the distance similarity Dn of the current vector joining the center and the subject area is assigned.

FIG. 5A illustrates an example of the image of a past frame as described above. The configuration illustrated in FIG. 5A is the same as that according to the first embodiment illustrated in FIG. 5A, and thus description thereof is omitted. FIG. 5E is a diagram illustrating an example of the image of a current frame according to the fourth embodiment.

In FIG. 5E, a current frame image 520, a subject area 521, a local portion area 522, and a local portion area 523 are illustrated. In addition, in FIG. 5E, a current vector 524 joining the center of a subject area 521 and the center of a local portion area 522 and a current vector 525 joining the center of a subject area 521 and the center of a local portion area 523 are illustrated.

Furthermore, a local portion area 522 that is originally desired to be associated with the subject area 521 is correct detection of the local portion area, and the local portion area 523 is incorrect detection. In the present embodiment, in Step S407, first, the angular similarity calculating unit 312 calculates the angular similarity S1 between the past vector 503 and the current vector 524 and the angular similarity S2 between the past vector 503 and the current vector 525.

Since the current vector 524 and the current vector 525 have similar angles (high cosine similarity) with the past vector 503, the angular similarity S1 and the angular similarity S2 are calculated to have almost the same value.

In other words, as illustrated in FIG. 5E, the fourth embodiment is effective in a case in which only the angular similarity Sn is insufficient as information of association in a scene in which the angles of the past vector and the current vector are the same. In Step S407, next, the distance similarity calculating unit 313 calculates distance similarity D1 between the past vector 503 and the current vector 524 and the distance similarity D2 between the past vector 503 and the current vector 525 using Equation 4 described above.

Since the current vector 524 has a distance that is more similar to the distance of the past vector 503 than the current vector 525 (a difference in the Euclid distance is small), the distance similarity D1 is calculated to be higher than the distance similarity D2

In Step S408, the second matching score calculating unit 314 of the similarity judging unit 202 calculates a second association score A2n between the subject and a candidate of the local portion. A second association score A2n is calculated for each area candidate of the local portion on the basis of the first association score A1n, the angular similarity Sn, and the distance similarity Dn in the information of the area candidate of each local portion. The calculation of the second association score A2n, for example, is performed as in the following Equation 5 but is not limited thereto.

$${A}_{2 n} = {A}_{1 n} \times {S}_{n} \times {D}_{n} \qquad ( Equation 5 )$$

Thus, the second association score A2n is acquired by correcting the value of the first association score A1n using the angular similarity Sn and the distance similarity Dn. In other words, for example, in FIG. 5E, the first association score A11 of the local portion area 522 and the first association score A12 of the local portion area 523 are of the same degree.

However, in the fourth embodiment, the second association score A21 of the local portion area 522 becomes higher than the second association score A22 of the local portion area 523. In Step S408, the image, the subject area, the area candidate of the local portion, and the second association score A2n are output to the association unit 203.

Next, in Step S409, the local portion determining unit 204 of the association unit 203 selects a local portion of which the second association score A2n is the highest among candidates of the local portion as a local portion accompanying the subject, and the local portion is associated.

In other words, in the fourth embodiment, since the second association score A21 is higher than the second association score A22, the local portion area 522 illustrated in FIG. 5E becomes the area of the selected local portion.

In Step S410, the display unit 205 of the association unit 203 displays the area of the selected local portion on the rear monitor 107 with being superimposed onto the image. In the fourth embodiment, in the current frame image 520 illustrated in FIG. 5E, the bounding box of the local portion area 523 is not displayed, and an image onto which the bounding box of the local portion area 522 is superimposed is displayed.

In addition, on the basis of the displayed local portion area 522, processes such as auto focusing and exposure control and the like are performed. However, the displayed information is not limited thereto, and the bounding box of the subject area 521 and the like may be displayed with being superimposed onto the current frame image 520.

As above, by performing Steps S400 to S410, for example, even in a case in which a plurality of subjects having the same posture are present, association between a subject and a local portion accompanying the subject can be performed more accurately.

### Fifth Embodiment

In a fifth embodiment, like the angular similarity according to the second embodiment in the fourth embodiment, a threshold is set also to the distance similarity, and association is performed in accordance with a result of comparison between the angular similarity with the threshold.

FIG. 3E is a functional block diagram illustrating a configuration example of a similarity judging unit 202 according to the fifth embodiment. The similarity judging unit 202 according to the fifth embodiment has a first matching score calculating unit 315, an angular similarity calculating unit 316, a distance similarity calculating unit 317, a similarity threshold checking unit 318, and a second matching score calculating unit 319.

The first matching score calculating unit 315, the angular similarity calculating unit 316, and the distance similarity calculating unit 317 respectively perform the same processes as those of the first matching score calculating unit 311, the angular similarity calculating unit 312, and the distance similarity calculating unit 313 according to the fourth embodiment, and thus description thereof is omitted.

The similarity threshold checking unit 318 updates the numerical value of the angular similarity Sn by comparing the angular similarity Sn with an angular similarity threshold Ts set in advance. In addition, by comparing the distance similarity Dn with a distance similarity threshold Td set in advance, the numerical value of the distance similarity Dn is updated.

Here, the similarity threshold checking unit 318 functions as a similarity threshold checking means that calculates a comparison result by comparing angular similarity with the angular similarity threshold and comparing distance similarity with the distance similarity threshold. In addition, in the fourth embodiment, the second matching score calculating unit 319 calculates a second association score on the basis of the comparison result described above and the first association score.

The second matching score calculating unit 319 performs a process similar to that of the second matching score calculating unit 314 according to the fourth embodiment, and thus description thereof is omitted.

Next, the process performed by the imaging apparatus 10 according to the present embodiment is described in detail along the flowchart illustrated in FIG. 4. However, the imaging apparatus may not necessarily need to perform all the steps described in this flowchart.

In Steps S400 to S406, processes similar to those of Steps S400 to S406 according to the first embodiment are performed, and thus description thereof is omitted.

In Step S407, first, the angular similarity calculating unit 316 of the similarity judging unit 202 calculates angular similarity Sn on the basis of a relative positional relation between a subject area and an area of a local portion in each of the past frame and the current frame.

Next, the distance similarity calculating unit 317 calculates distance similarity Dn on the basis of a relative positional relation between a subject area and an area of a local portion in each of the past frame and the current frame. More specifically, the distance similarity Dn between the past vector and the current vector is calculated.

Furthermore, the similarity threshold checking unit 318 updates the numerical value of the angular similarity Sn by comparing the angular similarity Sn with the angular similarity threshold Ts. In addition, the similarity threshold checking unit 318 updates the numerical value of the distance similarity Dn by comparing the distance similarity Dn with the distance similarity threshold Td. In Step S407, finally, to the area candidate of each local portion, information of the angular similarity Sn and the distance similarity Dn of the current vector joining the center and the subject area is assigned.

FIG. 5A illustrates an example of the image of a past frame as described above. The configuration illustrated in FIG. 5A is the same as that illustrated in FIG. 5A according to the first embodiment, and thus description thereof is omitted. FIG. 5C illustrates an example of the image of a current frame according to the fifth embodiment.

As described above, in Step S407, first, the angular similarity calculating unit 316 calculates angular similarity S1 between the past vector 503 and the current vector 513.

In addition, the distance similarity calculating unit 317 calculates distance similarity D1 between the past vector 503 and the current vector 513. Next, the similarity threshold checking unit 318 updates the value of the angular similarity S1 as in Equation 2 on the basis of the angular similarity S1 and the angular similarity threshold Ts. In addition, the similarity threshold checking unit 318 updates the value of the distance similarity D1 as in Equation 6 on the basis of the distance similarity D1 and the distance similarity threshold Td.

$${D}_{n} = max ( \begin{matrix}{D}_{n} - {T}_{d} \\ 0\end{matrix} ) \qquad ( Equation 6 )$$

In a case in which a value acquired by subtracting Td from the distance similarity Dn is larger than 0, the value is set as the distance similarity Dn. In a case in which the value acquired by subtracting Td from the distance similarity Dn is 0 or less, the value of the distance similarity Dn is set to 0. Although one distance similarity threshold Td may be used, it may be prepared for each category of subjects.

In addition, as in the third embodiment, the distance similarity threshold Td may be corrected for each frame using image-capturing information of the camera. In the fifth embodiment, the angular similarity S1 is assumed to be greater than the angular similarity threshold Ts. In addition, the lengths of the past vector 503 and the current vector 513 are different, and the distance similarity D1 becomes lower than the distance similarity threshold Td, whereby the distance similarity D1 becomes 0.

In Step S408, the second matching score calculating unit 319 of the similarity judging unit 202 calculates a second association score A2n between a subject and a candidate of the local portion. Although a representative process is the same as that of Step S408 of the fourth embodiment, the distance similarity D1 is 0 in the present embodiment, and thus the second association score A21 of the local portion area 512 becomes 0 in accordance with Equation 5.

In Step S408, the image, the subject area, the area candidate of the local portion, and the second association score A21 are output to the association unit 203.

In Steps S409 to S410, processes similar to those of Steps S409 to S410 according to the first embodiment are performed, and thus description thereof is omitted.

As described above, by performing Steps S400 to S410, for example, when only one candidate of the local portion is present, incorrect association between a subject and a local portion candidate not accompanying the subject can be suppressed.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the imaging apparatus or the like through a network or various storage media. Then, a computer (or a CPU, an MPU, or the like) of the imaging apparatus or the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2025-005107, filed on Jan. 15, 2025, which is hereby incorporated by reference herein in its entirety.

What is claimed is:

1. An imaging apparatus comprising: at least one processor; and a memory coupled to the at least one processor, the memory storing instructions that, when executed by the at least one processor, cause the at least one processor to:
detect a subject area by tracking a specific subject in consecutive images;
detect area candidates of a local portion accompanying the subject from within the images;
calculate similarity on the basis of a relative positional relation between the subject area and an area of the local portion associated with the subject in a past frame and a relative positional relation between the subject area and area candidates of the local portion in a current frame and calculate an association score on the basis of the similarity; and
perform association between the subject and the local portion on the basis of the association score.

2. The imaging apparatus according to claim 1, wherein the memory stores further instructions that, when executed by the at least one processor, cause the at least one processor to: calculate first association scores between the subject area and the area candidates of the local portion in the judgment of similarity.

3. The imaging apparatus according to claim 2, wherein the memory stores further instructions that, when executed by the at least one processor, cause the at least one processor to: calculate second association scores on the basis of the first association scores and the similarity.

4. The imaging apparatus according to claim 3, wherein the memory stores further instructions that, when executed by the at least one processor, cause the at least one processor to:
calculate angular similarity between a relative positional relation between the subject area and the area of the local portion associated with the subject area in a past frame and a relative positional relation between the subject area and area candidates of the local portion in the current frame in the judgment of similarity; and
calculate the second association scores on the basis of the angular similarity and the first association scores.

5. The imaging apparatus according to claim 4, wherein the memory stores further instructions that, when executed by the at least one processor, cause the at least one processor to:
in the judgment of similarity,
calculate a comparison result by comparing the angular similarity with a predetermined similarity threshold; and
calculate the second association scores on the basis of the comparison result and the first association scores.

6. The imaging apparatus according to claim 4, wherein the memory stores further instructions that, when executed by the at least one processor, cause the at least one processor to:
in the judgment of similarity,
acquire image-capturing information at a time of capturing the image; and
calculate the second association scores on the basis of the image-capturing information, the angular similarity, and the first association scores.

7. The imaging apparatus according to claim 4, wherein the memory stores further instructions that, when executed by the at least one processor, cause the at least one processor to:
in the judgment of similarity,
calculate distance similarity between a relative positional relation between the subject area and the area of the local portion associated with the subject area in a past frame and a relative positional relation between the subject area and the area candidates of the local portion in a current frame; and
calculate the second association scores on the basis of the angular similarity, the distance similarity, and the first association scores.

8. The imaging apparatus according to claim 7, wherein the memory stores further instructions that, when executed by the at least one processor, cause the at least one processor to:
in the judgment of similarity,
calculate a comparison result by comparing the angular similarity with an angular similarity threshold and comparing the distance similarity with a distance similarity threshold; and
calculate the second association scores on the basis of the comparison result and the first association scores.

9. The imaging apparatus according to claim 3, wherein the memory stores further instructions that, when executed by the at least one processor, cause the at least one processor to:
in the association,
select the area of the local portion associated with the subject area in a current frame on the basis of the second association scores; and
display the area of the associated local portion on a screen.

10. An imaging method comprising:
detecting a subject area by tracking a specific subject in consecutive images;
detecting area candidates of a local portion accompanying the subject from within the images;
calculating similarity on the basis of a relative positional relation between the subject area and an area of the local portion associated with the subject in a past frame and a relative positional relation between the subject area and area candidates of the local portion in a current frame and calculating an association score on the basis of the similarity; and
performing association between the subject and the local portion on the basis of the association score.

11. A non-transitory computer-readable storage medium configured to store a computer program comprising instructions for executing the following processes:
detecting a subject area by tracking a specific subject in consecutive images;
detecting area candidates of a local portion accompanying the subject from within the images;
calculating similarity on the basis of a relative positional relation between the subject area and an area of the local portion associated with the subject in a past frame and a relative positional relation between the subject area and area candidates of the local portion in a current frame and calculating an association score on the basis of the similarity; and
performing association between the subject and the local portion on the basis of the association score.
